(19) United States
(12) Patent Application Publication
(10) Pub. No.: US 2011/0093221 A1
(43) Pub. Date: Apr. 21, 2011

(54) SYSTEM TO MONITOR ENERGY USE

(76) Inventor: SAVRAJ SINGH DHANJAL, Pennington, NJ (US)

(21) Appl. No.: 12/906,860

(22) Filed: Oct. 18, 2010

Related U.S. Application Data
(60) Provisional application No. 61/252,588, filed on Oct. 16, 2009.

(51) Int. Cl. G06F 19/00

(52) U.S. Cl. 702/57

(57) ABSTRACT

A system to monitor energy use is disclosed. According to one embodiment, a computer-implemented method comprises receiving energy consumption data from a gateway, wherein the gateway receives the energy consumption data from an electricity meter. The energy consumption data is stored, and an energy consumption graph is calculated by using the energy consumption data. The energy consumption graph is transmitted to an end device, and the energy consumption graph is displayed on the end device.

The present application claims the benefit of and priority to application Ser. No. 61/252,588, titled “SYSTEM TO MONITOR ENERGY USE,” filed on Oct. 16, 2009, and is hereby incorporated by reference in its entirety.

### FIELD

The field of the invention relates generally to computer systems. In particular, the present invention is directed to a system to monitor energy use.

### BACKGROUND

An electricity (or electric) meter or energy meter is a device that measures the amount of electrical energy consumed by a residence, business, or an electrically powered device. Electric meters are typically calibrated in billing units, the most common one being the kilowatt hour. Periodic readings of electric meters establish billing cycles and energy used during a cycle. In settings when energy savings during certain periods are desired, meters may measure demand, the maximum use of power in some interval. In some areas, the electric rates are higher during certain times of day, to encourage reduction in use. Also, in some areas meters have relays to turn off nonessential equipment. Electricity meters are typically manually read by a human.

### SUMMARY

A system to monitor energy use is disclosed. According to one embodiment, a computer-implemented method comprises receiving energy consumption data from a gateway, wherein the gateway receives the energy consumption data from an electricity meter. The energy consumption data is stored, and an energy consumption graph is calculated by using the energy consumption data. The energy consumption graph is transmitted to an end device, and the energy consumption graph is displayed on the end device.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

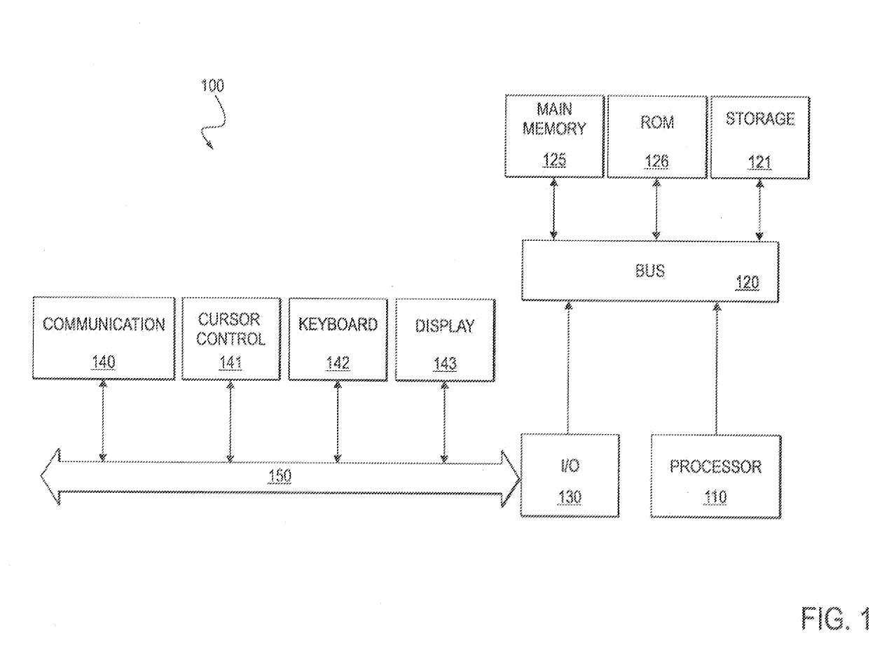

FIG. 1 illustrates an exemplary computer architecture for use with the present system, according to one embodiment.

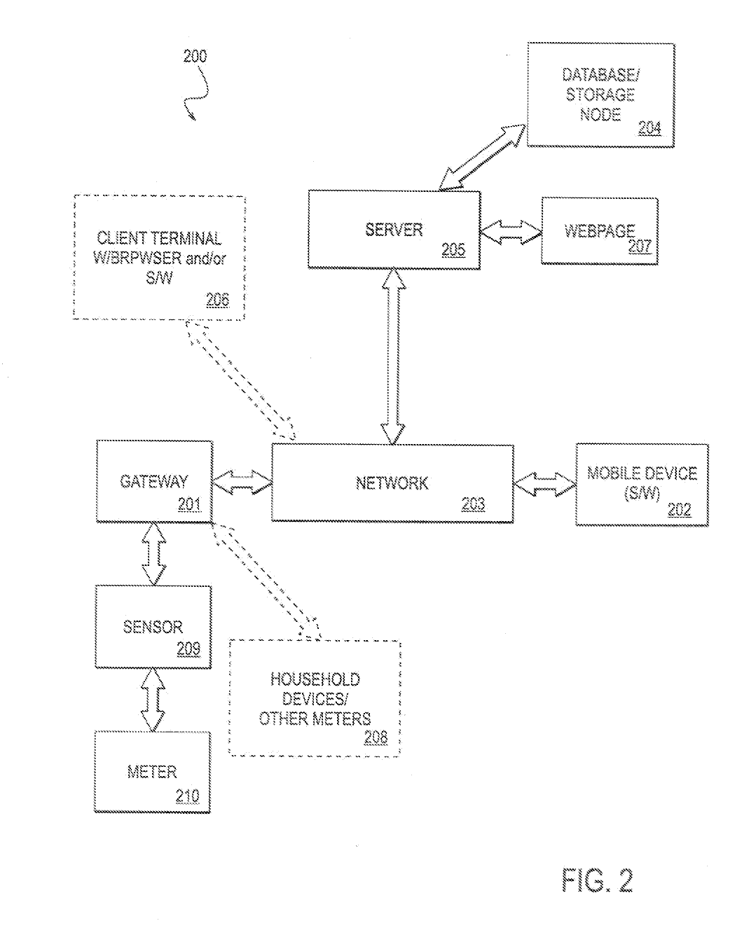

FIG. 2 illustrates an exemplary system level architecture for use with the present system, according to one embodiment.

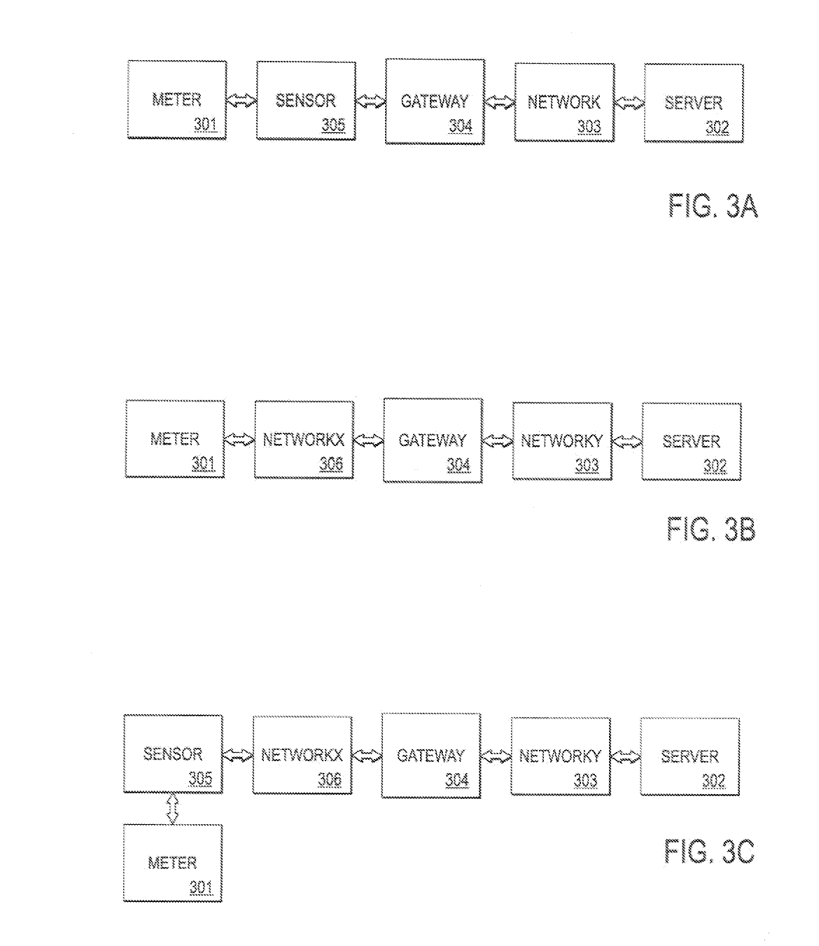

FIG. 3A illustrates an exemplary architecture for wireless communication between a sensor probe, gateway, and meter within the present system, according to one embodiment.

FIG. 3B illustrates an exemplary architecture for wireless and direct communication between a sensor probe, gateway, and meter within the present system, according to one embodiment.

FIG. 3C illustrates an exemplary architecture for direct communication between a sensor probe, gateway, and meter within the present system, according to one embodiment.

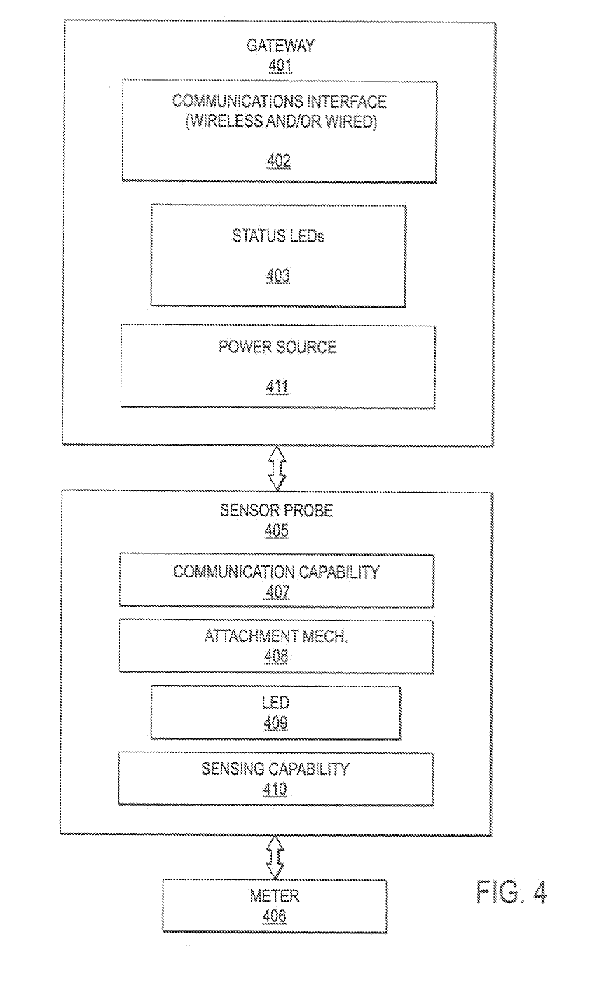

FIG. 4 illustrates an exemplary layout of a sensor probe, a gateway, and a meter for use with the present system, according to one embodiment.

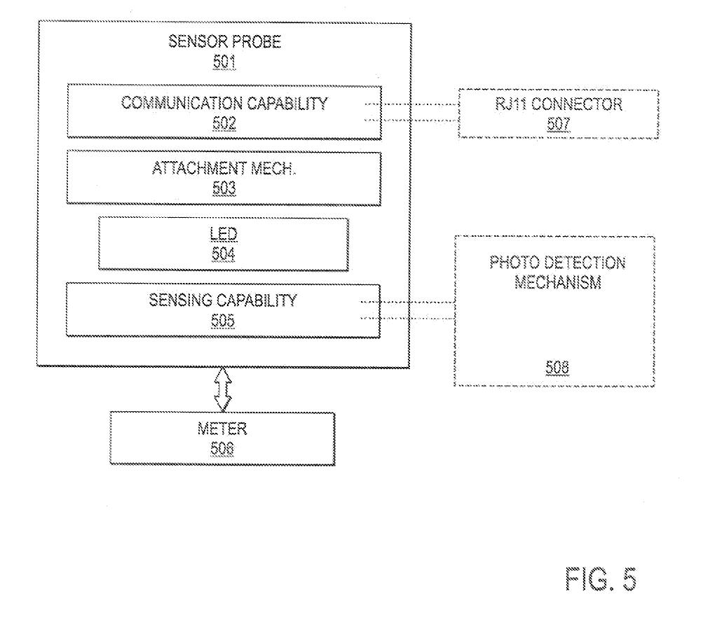

FIG. 5 illustrates an exemplary sensor probe for use with the present system, according to one embodiment.

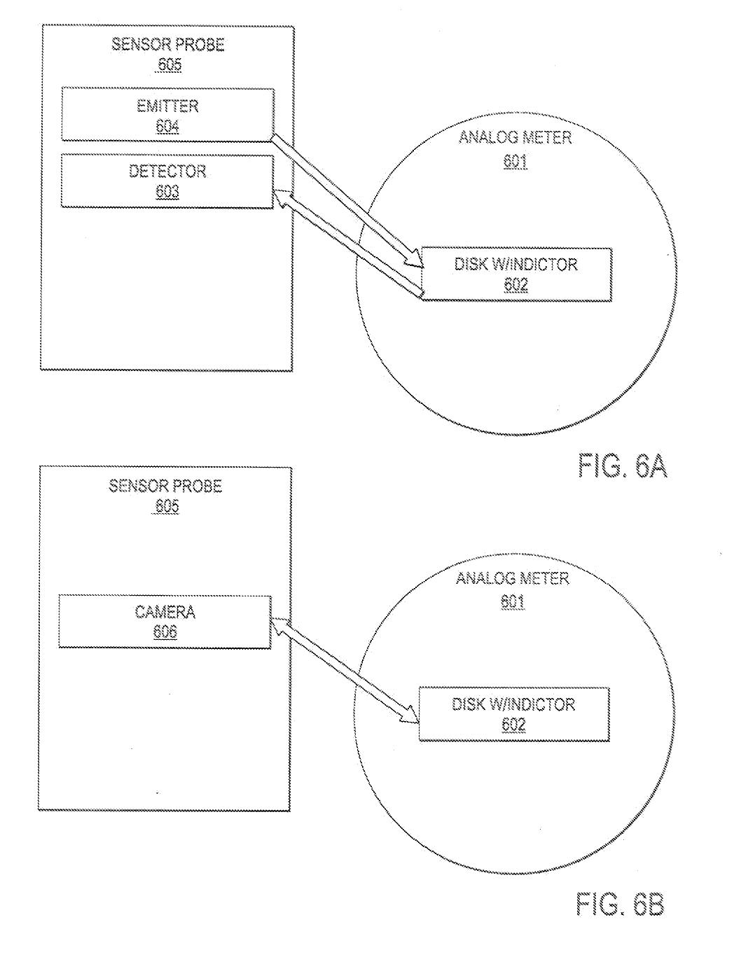

FIG. 6A illustrates an exemplary sensor probe for use with an analog meter within the present system, according to one embodiment.

FIG. 6B illustrates an exemplary sensor probe having a camera for use with an analog meter within the present system, according to one embodiment.

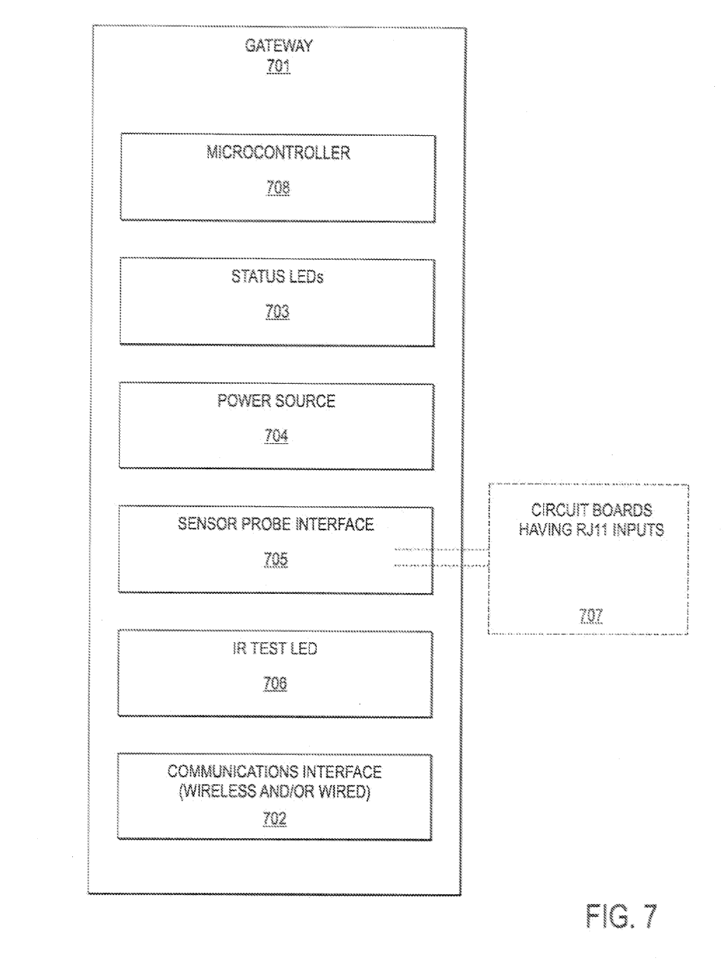

FIG. 7 illustrates an exemplary gateway for use with the present system, according to one embodiment.

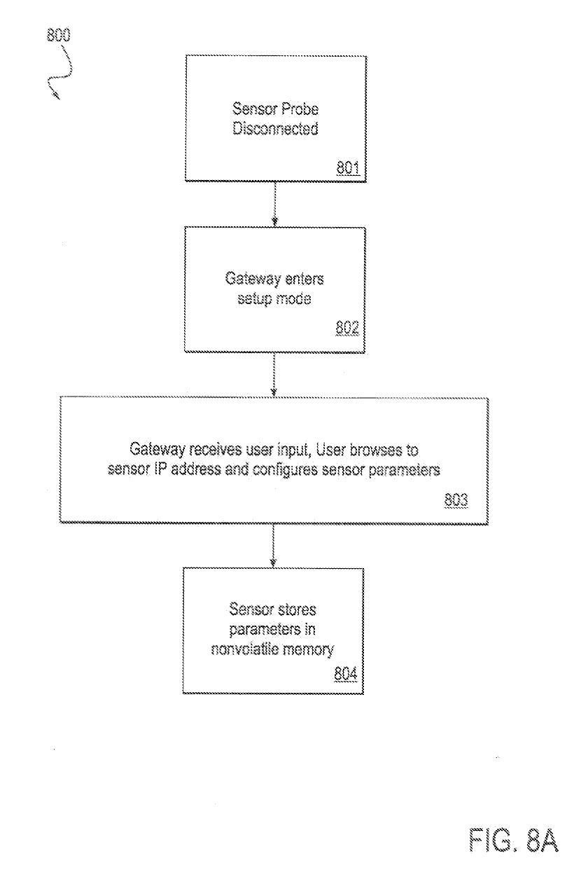

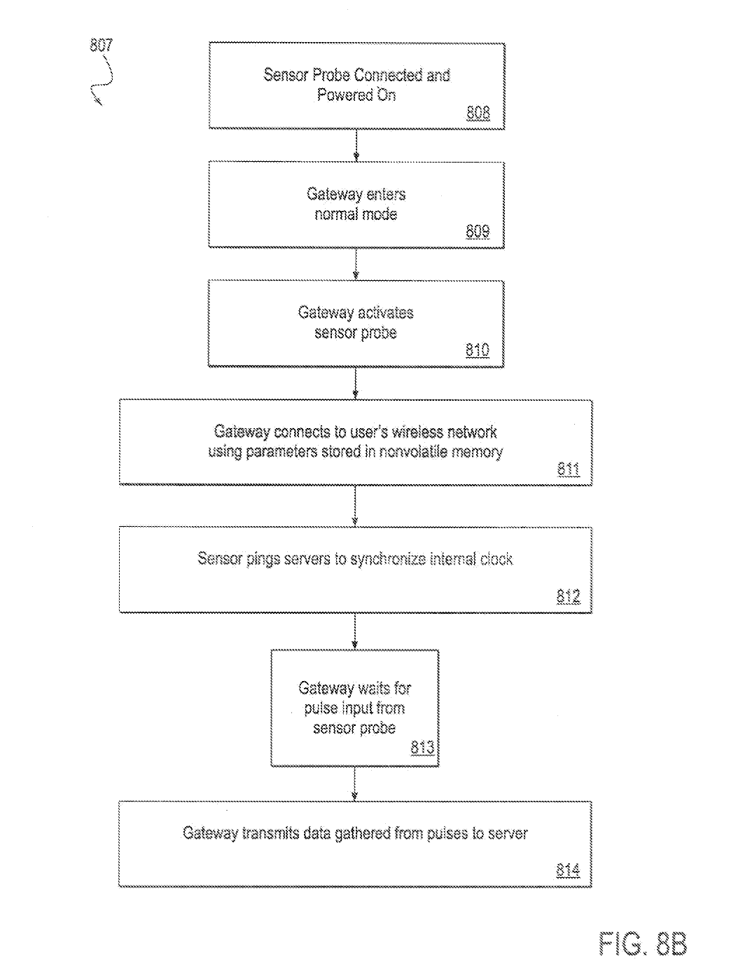

FIG. 8A illustrates an exemplary gateway setup mode operation for use with the present system, according to one embodiment.

FIG. 8B illustrates an exemplary gateway normal mode operation for use with the present system, according to one embodiment.

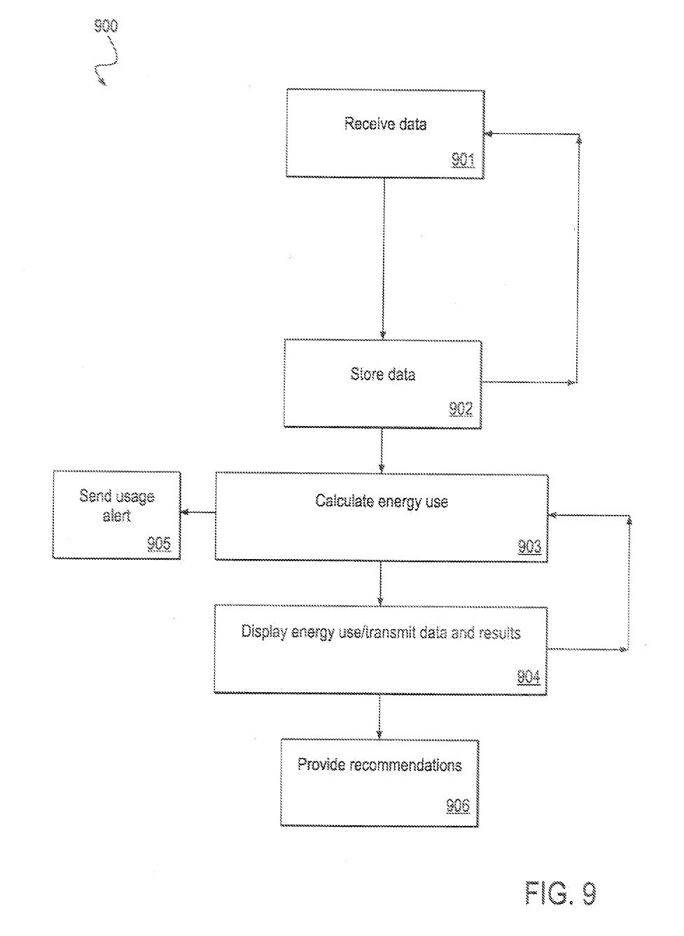

FIG. 9 illustrates an exemplary server operation process for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A system to monitor energy use is disclosed. According to one embodiment, a computer-implemented method comprises receiving energy consumption data from a gateway, wherein the gateway receives the energy consumption data from an electricity meter. The energy consumption data is stored, and an energy consumption graph is calculated by using the energy consumption data. The energy consumption graph is transmitted to an end device, and the energy consumption graph is displayed on the end device.

According to one embodiment, the present system enables the monitoring of energy use. The present system enables individuals to know how much energy they are consuming in real-time. Given this information, users can take immediate steps to reduce their energy consumption and carbon footprint.

According to one embodiment, the present system includes sensor hardware and software that enable users to view their live energy consumption on the web or on mobile or other display devices.

According to one embodiment, a sensor probe gathers energy consumption data and conveys it to a gateway, and the gateway connects to a server that stores and presents the data.

According to one embodiment, the energy consumption data is displayed on a cell phone or mobile device in real time. As a user walks around a house turning appliances and electronics things on and off, he/she can see the energy consumption graph change on the mobile device.

According to one embodiment, additional sensor probes for both gas and water meters are installed and monitored. The additional probes connect back to the same gateway, and a complete picture of a home or business' total energy consumption is provided through consumption data gathered for electric, gas, and water use. Additional plug-level probes may be added, so the energy use of particular devices can be tracked alongside the aggregate consumption.

According to one embodiment, sensor probes and plug-level probes are controlled from a website to activate and deactivate the devices plugged in to various sockets.

According to one embodiment, users are notified via email, text, or a phone call when consumption exceeds or drops below certain parameters.

According to one embodiment, a user can embed his or her energy use in an existing website or blog with a line of code so that others can view the user's energy use in real time.

According to one embodiment, a user can create a custom system for home energy monitoring. The user connects his or her own custom sensor hardware to the website by using the website's data upload and download APIs (application programming interfaces).

According to one embodiment, consumption data as referred to herein includes data indicating energy consumption by a user. It is also referred to herein as usage data, data, energy use data, and energy use. It is to be appreciated that consumption data can be data indicating consumption of other resources, examples of which include natural gas and water.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 125 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary system level architecture for use with the present system, according to one embodiment. An exemplary architecture 200 includes a server 205 in communication with a database or storage node 204 and in communication with a network 203. A gateway 201 is in communication with the network 203. The gateway 201 is in communication with a sensor probe 209 that reads consumption data from a meter 210. The gateway 201 can also be in communication with additional household devices and/or other meters 208. The server 205 receives consumption data from the gateway 201 and processes it. The server 205 hosts a website 207 that is accessible via the network 203. A mobile device having consumption monitoring software 202 is in communication with the network 203. The mobile device 202 receives consumption data from the server 205 via the network 203.

According to one embodiment, the exemplary architecture 200 includes a client terminal 206 having a browser in communication with the network 203. The client terminal 206 accesses the website 207 to monitor consumption data.

According to one embodiment, the exemplary architecture 200 includes additional household devices and/or other meters 208 in communication with the gateway 201. The server 205 receives energy use data from the additional household devices and/or other meters 208 via the gateway 201.

FIG. 3A illustrates an exemplary architecture for direct communication between a sensor probe, gateway, and meter within the present system, according to one embodiment. A meter 301 is in communication with a sensor probe 305. The meter 301 transmits usage data to the sensor probe 305. The sensor probe 305 is in communication with a gateway 304 and transmits usage data to the gateway 304 that is in communication with a network 305. The gateway 304 transmits the usage data over the network 305 to a server 302 that is also in communication with the network 305.

FIG. 3B illustrates an exemplary architecture for direct communication between a sensor probe, gateway, and meter within the present system, according to one embodiment. A meter 301 is in communication with a networkX 306. Meter 301 transmits consumption data over networkX 306 to a gateway 304. The gateway 304 transmits the usage data over a networkY 305 to a server 302 that is also in communication with the networkY 305.

FIG. 3B illustrates an exemplary architecture for direct communication between a sensor probe, gateway, and meter within the present system, according to one embodiment. A meter 301 is in communication with a sensor probe 305 that is in communication with a networkX 306. Meter 301 transmits consumption data to the sensor probe 305, and the sensor probe 305 transmits the consumption data over network 306 to a gateway 304. The gateway 304 transmits the consumption data over a networkY 305 to a server 302 that is also in communication with the networkY 305.

Is it to be appreciated that in the embodiments described herein, networkX and networkY are different networks, however in other embodiments they are the same network. Examples of networks that are used herein include Wi-Fi, a wired network, and a wireless protocol other than Wi-Fi.

FIG. 4 illustrates an exemplary layout of a sensor probe, a gateway, and a meter for use with the present system, according to one embodiment. A sensor probe 405 is in communication with a meter 406. The sensor probe 405 gathers usage data from the meter 406 and conveys the usage data to a gateway 401. According to one embodiment, the meter 406 has a wireless radio.

According to one embodiment, the gateway 401 communicates with the sensor probe 405 using a communication interface 402. The communication interface 402 can be wireless and/or wired. For example, if the meter 406 supports RS-485 communication, the gateway 401 and sensor probe 405 can be wired directly to the meter 406. The gateway 401 has status LEDs 403 and a power source 411.

According to one embodiment, the sensor probe 405 has communication capability 407 for communicating with the gateway 401, attachment mechanism 408 for attaching to a meter 406, an LED 409, and sensing capabilities 410 that read energy usage from the meter 406. The LED 409 blinks in proportion to energy use so a user can see that the sensor probe 405 is functioning.

According to one embodiment, the attachment mechanism 408 includes a strap system that allows attachment to a meter without leaving any permanent changes or marks. The straps use Velcro and other removable fasteners to make installation and removal simple for users.

According to one embodiment, sensing capabilities 410 include the sensor probe reading an infrared pulse emitted by the meter 406 that corresponds to the energy passing through the meter 406. As an example, a digital meter emits a pulse for every 1 watt-hour of energy that passes through it. By timing the difference between pulses, the gateway 401 can calculate the rate energy is being consumed. By counting the total number of pulses in a given period, the total energy used for that period can be calculated.

According to one embodiment, the sensor hardware (sensor probe 405 and gateway 401) uses Wi-Fi (e.g., 802.11b/g/n wireless standard), Ethernet, or other standardized protocol to communicate with a home's wireless network. It can also be adapted to use GSM or other wireless protocols, to sidestep a user's network and communicate directly with the servers, according to one embodiment.

According to one embodiment, the gateway uses less than one watt of power and is powered by a power outlet placed discreetly within a user's home or business. It may also be powered by solar power or other power source.

According to one embodiment, the status LEDs 403 include four LEDs that convey the status of the system. One LED displays whether the sensor probe 405 has power. One LED indicates whether the gateway 401 connected to the home network. One LED confirms the gateway's 401 connection to the server, and one LED blinks in proportion to energy consumption.

FIG. 5 illustrates an exemplary sensor probe for use with the present system, according to one embodiment. A sensor probe 501 includes communication capability 502 for communicating with a gateway. The sensor probe 501 also includes attachment means 503 and an LED 504 as described above in FIG. 4. The sensor probe 501 includes sensing capability 505 for sensing energy usage data from a meter 506.

According to one embodiment, the sensor probe 501 is designed to work with many types of meters. Digital meters have an infrared output port, which typically emits an infrared pulse every 1 watt-hour of energy consumed. In this case, the sensing capability 505 includes the ability to read infrared output from the meter 506.

According to one embodiment, the sensor probe 501 has four wires connected to it through an RJ11 port 507.

According to one embodiment, the wires are connected directly to a small circuit board within the sensor probe. The wires are power, ground, signal, and a wire for the status LED.

According to one embodiment, the sensor probe 501 includes a photo-detection mechanism 508 (e.g., Fairchild Optoelectronics model QSE159). The photo-detection mechanism 508 has three pins: power, ground, and signal. The status LED connects to the status LED wire and ground. The status LED also has a current limiting resistor in series with it.

FIG. 6A illustrates an exemplary sensor probe for use with an analog meter within the present system, according to one embodiment. For analog meters (or Ferraris Disk meters) 601, the sensor probe 605 observes the rotation of a disk 602, by using an infrared or visible light emitter 604 and detector 603 pair designed to observe a black spot (or indicator 602) on the disk 602.

According to one embodiment, the system is impervious to sunlight interference because the emitter 604 is modulated at a particular frequency, and the detector 603 only detects input at that frequency. This way, the sun or other light sources do not interfere with the normal operation of the system. The black patch or indicator 602 is seen by the emitter 604—detector 603 pair when the detector no longer sees a reflection from the silvered edge of the disk 602. Every time the Ferraris disk 602 completes one revolution, the building has consumed another X watt-hours of energy. By timing how long it takes for the wheel to make one revolution, the present system determines how many watts are being used by the house or building.

According to one embodiment, the emitter 604 emits a visible red light. This way, it is easy for a user to set up the system—they just make sure the red light is shining on the edge of the disk, eliminating any setup troubles.

According to one embodiment, an LED on the emitter 604—detector 603 pair lights up when the black spot on the edge of a disk 602 is detected.

According to one embodiment, the sensor probe 605 is positioned such that the red light from the emitter 604 is on the edge of the disk, making sure the LED lights up when the black patch passes under the red light.

According to one embodiment, the analog sensor probe 605 is connected to the gateway. The four wires transmit power, ground, sensor signal, and status LED state. When the sensor probe 605 is sensing the reflection of the disk 602, the signal wire is held “low.” When the sensor probe 605 senses the black patch on the disk 602, the signal wire pulses “high.”

FIG. 6B illustrates an exemplary sensor probe having a camera for use with an analog meter within the present system, according to one embodiment. A sensor probe 605 receives data from a digital camera 606 that observes the rotational speed of the disk 602 of an analog meter 601. With the rotational speed, the rate at which energy is being consumed is known, and by counting the total number of rotations in a given period, the total energy used in that period can be calculated.

FIG. 7 illustrates an exemplary gateway for use with the present system, according to one embodiment. A gateway 701 includes a microcontroller 708 for processing data and controls, a communication interface 702, a power source 704, and a sensor probe interface 705. It also has status LEDs 703 that indicate Wi-Fi status, power status, server connection status, and system status.

According to one embodiment, the gateway includes a circuit board that has several RJ11 jacks 707 to allow connection of sensor probes.

According to one embodiment, the gateway includes a module that enables direct wireless communication with a meter, sensor probes, or other appliances.

According to one embodiment, the gateway includes an infrared test LED 706 that simulates the pulse emitted by the meter. This makes it possible for users to test their digital sensor probe to confirm it is operating correctly, before placing the sensor out on the meter. To perform the test, a user can wave the digital sensor probe in front of the infrared LED on the gateway. The sensor will detect it, confirming that the system works.

The gateway has two operational modes—setup mode and normal mode. In setup mode, the gateway accepts setup information from the user, (e.g. the user's wireless network name, password, and other configuration information). In normal mode, the gateway uses this information to connect to the network and upload data from the sensor probe.

FIG. 8A illustrates an exemplary gateway setup mode operation for use with the present system, according to one embodiment. An exemplary gateway setup mode operation 800 begins with a sensor probe being disconnected 801 and the gateway enters setup mode 802. The gateway receives user input, and the user browses to a sensor IP address and configures the sensor parameters 803. The sensor stores the parameters in nonvolatile memory 804.

When the sensor probe is disconnected, the gateway defaults to setup mode. In setup mode, the gateway creates an ad-hoc wireless network, for example named “Setup [deviceID]” and hosts a small webserver. A user's laptop can connect to this “Setup” network, and then browse to the sensor's IP address (an example default value is http://169.254.4.4) in his or her browser. After browsing there, a user can configure parameters on the sensor, so that the sensor can connect to a user's wireless network. Once the parameters are configured (wireless network name, password, and security type, for example) the sensor stores these values in non-volatile memory.

FIG. 8B illustrates an exemplary gateway normal mode operation for use with the present system, according to one embodiment. An exemplary gateway normal mode operation 807 begins with a connected and powered on sensor probe 808 and the gateway enters normal mode 809. The gateway activates the sensor probe 810, and then attempts to connect to the user's wireless network using the parameters stored in non-volatile memory 811. Once a connection is made the Wi-Fi LED turns on, and the sensor then pings the servers to synchronize its internal clock 812. Once time synchronization is complete, a link LED turns on to indicate a successful time synchronization and communication with the servers. The gateway waits for new pulse input from the sensor probe 813, and then uploads the data gathered from these pulses using an HTTP POST directly to the servers 814. In the case of digital meters, the gateway counts the number of pulses coming in, and also measures the time between pulses. A count of pulses indicates how much energy has been consumed, and the rate of consumption can be determined by measuring the time between pulses. The gateway takes these two data points and uploads them to the server over the wireless internet connection via an HTTP POST, and this data is encrypted. It uploads new values every 8 seconds, according to one embodiment. If no pulse has been seen for 8 seconds, it does not post a new upload.

FIG. 9 illustrates an exemplary server operation process for use with the present system, according to one embodiment. An exemplary server operation process 900 begins with a server receiving data 901 from a gateway. The server then stores the data 902 either locally or on a storage node as depicted in FIG. 2. The server calculates 904 energy uses and transmits the results for display at another device 904. A user can browse this data, share it with friends, and compare it to the energy use of others.

According to one embodiment, the server provides recommendations 906 for energy savings. In one embodiment, users can set and track goals and savings associated with energy use.

According to one embodiment, the server also sends usage alerts 905. Usage alerts can be for when energy use is especially high or low, or when a sensor is no longer connected to the server. This is all configured through the web interface or on the mobile phone interface.

According to one embodiment, an icon representing a user's home or building is displayed to the user. The icon represents a house, and reflects a home's energy use in relation to the other homes on the system. If the home is displayed as having a red roof, it is using more energy than the average on the system. If the home is displayed as having a green roof, it is using less energy than the average energy use across all homes/buildings on the system. A user, as a result, can quickly see whether he or she is consuming more or less than an average energy use.

According to one embodiment, the server can also allow users to select portions of their energy use graph that represent particular appliances, allowing them to compare particular appliances with those of other users.

According to one embodiment, the server software draws conclusions about what appliances are represented in a user's energy use graph by comparing the data against known values and patterns.

According to one embodiment, the gateway also works with existing sub-metering applications. In some cases, landlords or other property owners install their own meters to sub-meter particular units or properties. These meters often have RS-485 or other communication ports, so the gateway can communicate directly with these meters—one only needs the RS-485 adapter, which plugs into an RJ11 jack of the gateway and wires directly to the sub-meter.

According to one embodiment, third party software developers or companies can create products and websites that use energy usage data extracted through the present system. This is enabled through an application programming interface that the system exposes. The live data gathered by sensors is available for use by third party applications.

A system for monitoring energy use has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

I claim:

1. A computer-implemented method, comprising:
receiving energy consumption data from a gateway, wherein the gateway receives the energy consumption data from an electricity meter;
storing the energy consumption data;
calculating an energy consumption graph by using the energy consumption data; and
transmitting the energy consumption graph to an end device, wherein the energy consumption graph is displayed on the end device.

2. The computer-implemented method of claim 1, wherein the gateway receives the energy consumption data from a sensor probe.

3. The computer-implemented method of claim 1, wherein the gateway comprises:
a microcontroller;
a communication interface;
a power source;
a sensor probe interface; and
status LEDs.

4. The computer-implemented method of claim 2, wherein the sensor probe comprises:
an attachment mechanism;
sensing capability;
an LED; and
communication capability.

5. The computer-implemented method of claim 4, wherein the sensor probe further comprises a photo detection mechanism.

6. The computer-implemented method of claim 2, wherein the sensor probe comprises a camera that detects disk rotation.

7. The computer-implemented method of claim 2, wherein the sensor probe comprises an emitter-detector pair that detects disk rotation.

8. The computer-implemented method of claim 3, wherein the gateway further comprises a test LED.

9. The computer-implemented method of claim 1, wherein the gateway a normal operation mode and a setup operation mode.

10. A system, comprising:
a gateway in communication with an electricity meter and a network; and
a server in communication with the network, wherein the server
receives energy consumption data from the gateway, wherein the gateway receives the energy consumption data from the electricity meter;
stores the energy consumption data;
calculates an energy consumption graph by using the energy consumption data; and
transmits the energy consumption graph to an end device, wherein the energy consumption graph is displayed on the end device.

11. The system of claim 10, wherein the gateway receives the energy consumption data from a sensor probe.

12. The system of claim 10, wherein the gateway comprises:
a microcontroller;
a communication interface;
a power source;
a sensor probe interface; and
status LEDs.

13. The system of claim 11, wherein the sensor probe comprises:
an attachment mechanism;
sensing capability;
an LED; and
communication capability.

14. The system of claim 13, wherein the sensor probe further comprises a photo detection mechanism.

15. The system of claim 11, wherein the sensor probe comprises a camera that detects disk rotation.

16. The system of claim 11, wherein the sensor probe comprises an emitter-detector pair that detects disk rotation.

17. The system of claim 12, wherein the gateway further comprises a test LED.

18. The system of claim 11, wherein the gateway a normal operation mode and a setup operation mode.

19. The system of claim 11, further comprising a gas consumption meter in communication with the gateway.

20. The system of claim 11, further comprising a water consumption meter in communication with the gateway.

21. The system of claim 10, wherein the server further provides recommendations based on the energy consumption graph.

22. The system of claim 21, wherein the recommendations are generated in comparison to energy consumed by another user.

23. The system of claim 10, wherein the server identifies an appliance based upon energy consumption data.
